(19) United States
(12) Patent Application Publication
(10) Pub. No.: US 2003/0083931 A1
(43) Pub. Date: May 1, 2003

(54) METHOD OF LOCALIZED NETWORK MARKETING

(75) Inventor: BROOK LANG, REDMOND, WA (US)

Correspondence Address: DEAN A CRAINE, CRAINE ASSOCIATES INC, 400 112TH AVENUE N E SUITE 140, BELLEVUE, WA, 98004

(73) Assignee: CRANE ASSOCIATES INC

(21) Appl. No.: 09/327,107

(22) Filed: Jun. 7, 1999

Related U.S. Application Data
(60) Provisional application No. 60/105,228, filed on Oct. 21, 1998.

(51) Int. Cl. G06F 17/60

(52) U.S. Cl. 705/14

(57) ABSTRACT

A method of advertising to mobile users of an electronic device linked to a wide area network. The method enables advertisers to more effectively target their advertisements to mobile users using a user file that includes their electronic device ID information, their past, current network connection activity, and the past, current or anticipated physical locations. The method includes the first step of obtaining the device's ID information when connected to the wide area network. Next, information regarding the network connection activity of the electronic device or the user over the wide area network is obtained. Next, the past, current or anticipated physical locations of the electronic device when connected to the wide area network is determined. Other personal data regarding the principle user of the electronic device may also be added to the user file to further target specific users. All of this information is then collected by a database generator to create a user file which may then distributed to advertisers. Based on the user file information, selective advertisements from the advertisers may be transmitted to targeted users over the wide area network to their electronic devices.

This is a utility patent application based on a provisional patent application (Serial No. 60/105,228) filed on Oct. 21, 1998.

### BACKGROUND OF THE INVENTION

1. Field of the Invention

The present invention relates generally to the field of marketing and advertising. More particularly, this invention relates to a method of marketing wherein an advertiser desiring to promote its goods or services to a targeted group of consumers who use a computer linked to a wide area network.

2. Description of the Related Art

Most advertising schemes attempt to improve the cost effectiveness of advertising by first identifying their customers and then targeting their advertisements to them. Today, it is desirable for advertisers to use the same tactics to target users connected to a wide area network, such as the INTERNET.

In order to effectively target advertisements to users of computers connected to a wide area network, the advertisers must use some method to deliver advertisements. After a delivery scheme has been adopted, the advertisers must use some distinguishing criteria, such as age, gender, occupation, hobbies, other interests, purchases, etc. to identify and sort out potential customers.

It is well known that information regarding the web sites visited or items purchased by a computer user connected to the wide area network may be used to identify potential customers. One common method used to identify prior visitors of a particular web site is for the network server to generate and transmit a “cookie” to the user's computer when the user visits a web site for the first time. Later when the user returns to the web site, the network server detects the “cookie” and regards the user as a return visitor. With this information, the network server can then transmit new data or advertisements to the user not originally transmitted to the user in the first visit.

Ideally, it is desirable to know the network address of the user's computer so that advertisements may be transmitted directly to the computer when connected to the wide area network. If the user has established a permanent account setup at a network service provider, also known as an Internet Service Provider (a.k.a. ISP), a permanent numerical address (called an Internet Protocol Address, a.k.a. IP) is assigned to the user. In some instances, personal information about the user or users of the computer is also given to the ISP. Every time the user uses a computer to connect to the wide area network, the user's computer is identified by the user's IP. If a permanent account has not been set up by a network service provider, the user must use a client software program, such as AMERICA ON-LINE 4.0, which contains account information and a log-on password which are downloaded to a central server each time the user connects to the network. With each “log-on” connection, a temporary numerical address is assigned to the user's computer by the network's server. In either situation, the electronic device's identification information or the numerical address is obtained. The electronic device's identification information and personal information about the user, of course, would be useful to advertisers so that they could deliver their advertisements to the users.

More recently, wireless network services have become available which enable users to use their mobile electronic devices to connect to the wide area network while they are travelling. Information regarding the specific location of these electronic device when connected to the wide area network would be desirable so that local advertisers may use this location information to more effectively target their advertisements to their users.

### SUMMARY OF THE INVENTION

It is an object of the present invention to provide a method of marketing goods or services to users connected to a wide area network, via a mobile electronic device.

It is another object of the present invention to provide such a method of marketing that enables advertisers to more specifically target their advertising to such users or their electronic devices according to the web sites or files previously visited on the wide area network.

It is a further object of the invention to provide such a method of advertising that enables advertisers to more effectively target customers by using the past, present, and future physical locations of their customers when connected to the wide area network.

These and other objects of the invention are met by an improved method of marketing to users of mobile computers or similar electronic devices linked to a wide area network. By using this method, advertisers are able to more effectively target their advertisements to users of the electronic devices according to their past web sites or files visited on the wide area network and their past, present, and anticipated future physical locations when connected to the wide area network.

The improved method includes the first step of identifying the electronic device connected to a wide area network. This information, known as the computer's ID information, may be the computer's permanent or temporary numerical address when connected to the wide area network or some other information closely associated to the computer or electronic device, such as the telephone number used to connect to the wide area network.

Next, the physical location of the electronic device when connected to the wide area network is obtained using a physical location detection means coupled to the computer or electronic device. In the embodiments described herein, the physical location detection may be a cellular telephone network, GPS system, or a ground based communication transmission system coupled to the computer or electronic device.

Next, information regarding the web sites or files visited over the wide area network by the user of the electronic device is obtained. Such information may be obtained by searching for “cookies” on the electronic device or by reviewing the network activity records on the user's network service provider server.

All of the above information is then collected by a database generator to create a user file. When a plurality of user files are created, the database generator transmits ads to selected users of electronic devices over the wide area network for a particular advertiser, or delivers all or selected portions of the database to advertisers to transmit advertisements themselves over the wide area network to these users. In each delivery scheme, the advertisements transmitted to targeted users are based on their electronic device's ID identification information, the electronic device's or user's network activities on the wide area network and the past, present or future physical locations of the electronic device or user when connected to the wide area network. In addition, the actual name of the user may be used and added to the user file. Other personal information about the user, such as name, gender, age, occupation, marital status, etc., may also be collected and added to the user file to further target the users.

### BRIEF DESCRIPTION OF THE DRAWINGS

FIG. 1 is a flow chart diagram of the marketing method disclosed herein using a mobile electronic device connected to a wide area network via a wireless communication system and a server connected to the wide area network and operated by the data generator showing the creation of user files.

FIG. 2 is a flow chart diagram of the marketing method shown in FIG. 1, showing the direct transmission of advertisements from advertisers to targeted users of electronic devices connected to the wide area network.

FIG. 3 is a flow chart diagram of the marketing method shown in FIG. 1, showing the transmission of advertisements by the data generator to targeted users of electronic devices connected to the wide area network.

### DESCRIPTION OF THE PREFERRED EMBODIMENT(S)

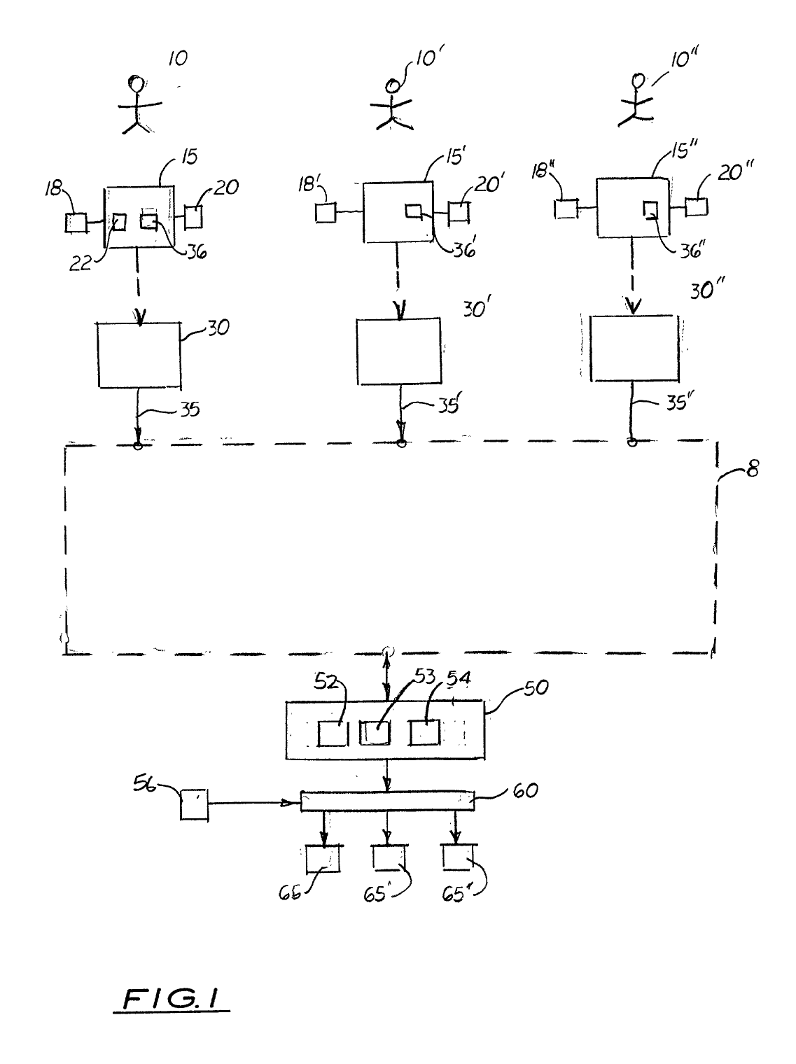

Referring to FIGS. 1-3, there is shown a method of marketing to a plurality of users 10, 10′, 10″ which use an electronic device, such as a laptop, 15, 15′, 15″, respectively, to connect to a wide area network 8 while travelling. In the embodiment shown herein, each laptop 15, 15′, 15″ is connected to a wireless modem 18, 18′, 18″ capable of connecting to a wireless network 30, 30′, 30″ respectively. Each wireless network 30, 30′, 30″ may be connected to a wide area network 8 to which a central server 50 is also connected. The wireless networks 30, 30′, 30′ may connect to the wide area network 8 via a land line or wireless communication connection, generally referenced as 35, 35′ and 35″.

Each laptop 15, 15′, 15″ is also coupled to a physical location indicating means 20, 20′, 20″, respectively. When each laptop 15, 15′, 15″ is connected through the wide area network 8 to the central server 50, the physical location indicating means 20, 20′, 20″ simultaneously transmits data informing the central server 50 of the physical location of the laptop 15, 15′, 15″ at that moment. In the preferred embodiment, the physical location indicating means is a Global Positioning Satellite receiver which receives global coordinate information from overhead satellites. Loaded into the laptop 15, 15′, 15″ is a software program 36, 36′, 36″ which transmits the present or past coordinate information from the receiver to the central server 50 when connected thereto.

The Global Positioning System (GPS) is a location system based on a constellation of twenty four satellites orbiting the earth at altitudes of approximately 11,000 miles. The GPS satellites provide accurate positioning information twenty-four hours per day, anywhere in the world. GPS uses a receiver which stores orbit information at all GPS satellites. During use, a land based receiver determines the time and the positions of the overhead satellites and then calculates the amount of time it takes a GPS radio signal to travel from the satellites to the receiver. By measuring the amount of time it takes for a radio signal to travel from the satellites, the exact location of the GPS receiver can be determined. GPS receivers are available from Corvallis Microtechnology, Inc., in Corvallis, Oreg. It should be understood however, that other means for determining the user's physical location may be used, such as the user's telephone number or area code information.

The first step in the marketing method disclosed herein is identifying the laptop 15, 15′, 15″ when connected to the wide area network 8. This is accomplished by determining the electronic device's ID information 52. If the central server 50 is also the user's network service provider to the wide area network 8 and a previously established account has been set up on the central server 50, the numerical or temporary address assigned to the user 10 by the service provider may be used as the electronic device's ID information 52. If the laptop 15, 15′, 15″ does not have a previously established account on the central server 50, a client software program, denoted 22 in FIG. 1, supplied by the operator of the central server 50, must be loaded into the laptop 15, 15′ or 15″ and used to connect it to the central server 50. During use, the user's personal information is entered into the client software program 22 by the user 10 which is automatically transmitted to the central server 50 when the user 10 connects to the central server 50 over the wide area network 8. The central server 50 then temporarily assigns the electronic device ID information 52 to the laptop 15.

Next, network activity information 53 regarding the web sites or files visited by the user 10 using the laptop 15 over the wide area network 8 is compiled. Such network activity information 53 may be obtained from the client software program 22 initially used to log on to the central server 50, or from additional forms and questionnaires submitted by the user 10, or by monitoring the network connection activity when the central server 50 acts as the user's network service provider. Information regarding the web sites visited by the user 10 using the laptop 15 may also be obtained by reviewing “cookies” stored on the laptop 15 when connected to the central server 50.

When each user 10, 10′, 10″ uses their laptop 15, 15′, 15″, respectively, to connect to the central server 50, the past and present physical location information 54 of the laptop 15, 15′, 15″ when connected to the wide area network is automatically downloaded to the central server 50 using the physical location means 20, 20′, 20″, discussed above. Future physical location information 54 can also be obtained by reviewing prior network connection information on the central server 50 or from information submitted by the user 10.

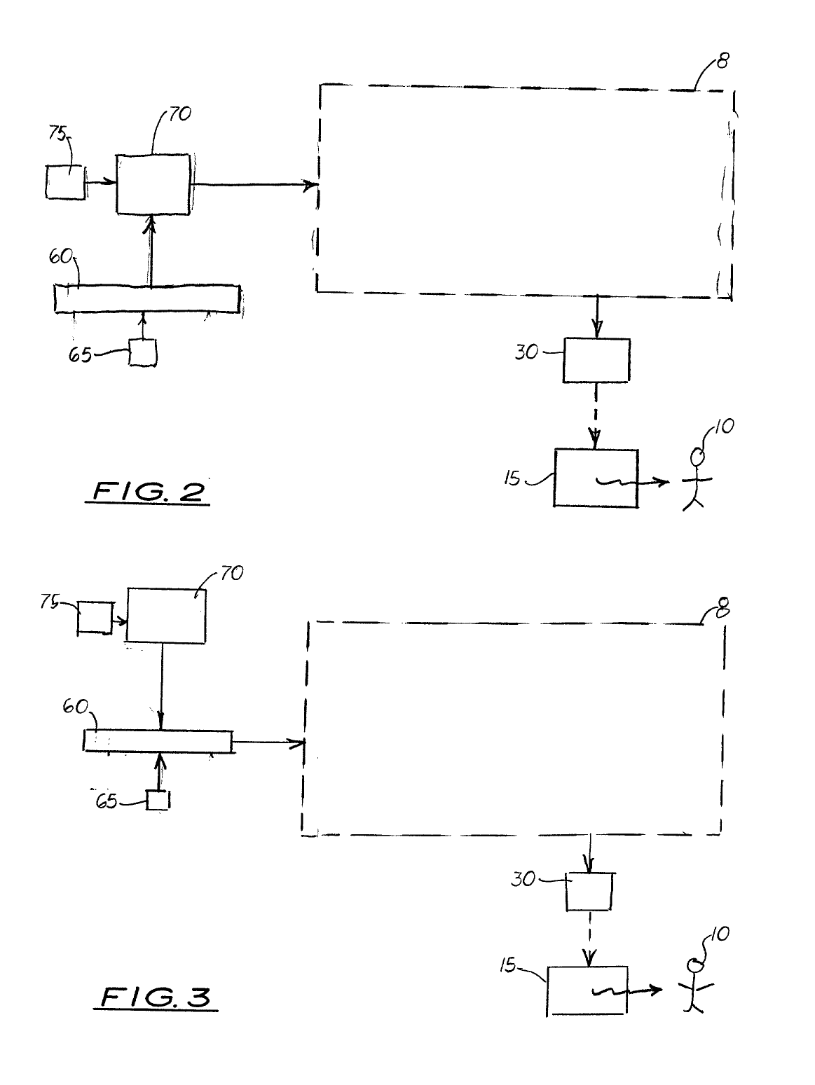

All of the above information 52, 53, 54 is collected from the central server 50 by a database generator 60. Additional personal user information 56 (i.e. age, gender, education, occupation, hobbies, etc.) regarding the user 10, 10′, 10″ may also be obtained from other sources and collected by the database generator 60. All of this information is collected by the database generator 60 to create a user file 65, 65′, 65″ for each user 10, 10′, 10″, respectively. When a sufficiently large number of user files 65, 65′, 65″ have been created, the database generator 60 may contact potential advertisers 70 interested in sending advertisements 75 to targeted users 10 or laptops 15 based on the information contained in these user files 65, 65′, 65″, respectively. As shown in FIGS. 2 and 3, the advertisers 70 may hire the database generator 60 to transmit their advertisements 75 to targeted users 10, 10′, 10″ or laptops 15, 15′, 15″ or may purchase selected user files 65, 65′, 65″ from the database generator 60 and transmit the advertisements 75 directly themselves to the targeted users 10, 10′, 10″ or laptops 15, 15′, 15″ over the wide area network.

The following two examples illustrate how the method is to be used:

### EXAMPLE 1

An automobile dealership in Seattle, Wash., wants to sell more automobiles. It currently has a web site on a wide area network, such as the INTERNET, which offers automobiles for sale to its visitors. Very few automobiles, to date, have been sold through its web site. Studies indicate that more than 95% of its sales are to customers located within twenty-five miles of the business. It knows however, that approximately 5% of its sales are to customers who live outside the twenty-five mile radius but who, nevertheless, make the long trip to the dealership to purchase an automobile. In the Seattle area, 70% of the homes are connected to the INTERNET, 20% of the adults are connected to the INTERNET via a wireless communication network, and over 50% of the adults have cellular telephones.

Many mobile computer users connect to the INTERNET via a wireless network. Connected to the INTERNET is a network server which collects the user's ID information from third parties or by individuals who visit the web site. The network server also has means to collect physical location information and the network activity information when they are connected to the INTERNET. A database generator is able to gather this information from the network server and create user files.

In order to sell more automobiles, the dealership generates a list of past visitors to its web site. Each time an individual visits the web site, they are required to log on by submitting their name, physical address, and e-mail address. When connection is made to their web site, the auto dealership's network server sends a cookie to the visitor's computer identifying it as a past visitor.

The dealership produces advertisements which it wants to transmit to each past visitor of its web site when they are within two miles of the dealership. In order to do so, the dealership contacts the database generator and requests the user files of past visitors. These past visitors are identified by their e-mail address. Using this information, the database generator is able to transmit advertisements for the dealership to past visitors of the dealership's web site when they are within two miles of the dealership and connected to the INTERNET.

### EXAMPLE 2

Tom is married, an avid golfer and likes Italian food. He is also a salesman who travels daily in his automobile servicing his clients located in a one-hundred mile radius from his home. Located in his automobile is a laptop computer with a wireless modem that enables Tom to connect to the INTERNET via a wireless ISP (Internet Service Provider). A GPS receiver is also connected to Tom's laptop computer. The central server for the ISP is able to receive location information from the GPS receiver so that the physical location of the laptop computer may be immediately determined by the central server when Tom is connected to the INTERNET.

When Tom initially enters his automobile and starts his laptop computer, the laptop computer automatically connects to the INTERNET using the wireless ISP. Since Tom has previously set up his account on the ISP, the central server immediately knows Tom's user ID information and begins to receive real time location information via the GPS receiver connected to Tom's laptop computer. As Tom travels during the day, the central server sends advertisements to Tom's laptop computer based on his user ID information, the physical location information and the network activity information, all contained in Tom's user file collected from the central server by the database generator.

In compliance with the statute the invention described herein has been described in language more or less specific as to structural features. It should be understood, however, that the invention is not limited to the specific features shown, since the means and construction shown comprised only the preferred embodiments for putting the invention into effect. The invention is therefore claimed in any of its forms or modifications within the legitimate and valid scope of the amended claims, appropriately interpreted in accordance with the doctrine of equivalents.

I claim:

1. A method of marketing to users of an electronic device connected via a wireless connection to a wide area network, comprising the following steps:
a. identifying an electronic device connected to a wide area network;
b. determining the physical location of said electronic device when connected to said wide area network;
c. creating a user file containing the identity and physical location information of said electronic device;
d. selecting advertising material to be sent to said electronic device; and
e. transmitting said advertising material to said electronic device over said wide area network using the identity and physical location information in said user file.

2. A method of advertising as recited in claim 1, wherein step (b) is carried out using physical location information transmitted by said electronic device when connected to said wide area network.

3. A method of marketing, as recited in claim 2, wherein the step (b) of determining the physical location of said electronic device is accomplished using a global positioning satellite system which provides global coordinate information of said electronic device when connected to said wide area network.

4. A method of marketing, as recited in claim 1, wherein said step (b) is carried out by a wireless modem connected to said electronic device and a cellular telephone system capable of determining the physical location of said wireless modem used to connect said electronic device to said wireless network.

5. A method of marketing, as recited in claim 1, further including a server connected to said wide area network, said server capable of receiving said identity and physical location information to create said user file.

6. A method of marketing, as recited in claim 1, further including an additional step between steps (c) and (d) of determining the network connection activities of said electronic device when connected to said wide area network, said network connection activities being added to said user file.

7. A method of marketing, as reciting in claim 6, wherein the step of determining the network connection activities of said electronic device is carried out by determining the existence of “cookies” on said electronic device.

8. A method of marketing, as recited in claim 1, further including the step of identifying the user of said electronic device.

9. A method of marketing, as recited in claim 8, wherein said user file contains user identification information and is used to transmit advertising to said electronic device.

10. A method of localized network marketing, comprising the following steps:
a. identifying an electronic device having means to make a wireless connection to a wide area network;
b. identifying a user of said electronic device;
c. determining the physical location of said electronic device when connected to said wide area network;
d. determining the network connection activities of said electronic device;
e. creating a user file containing information of the identity of said electronic device, and the physical location of said electronic device when connected to the network;
f. selecting advertising material; and
g. transmitting said advertising material over said wide area network using the identity and physical location information in said user file.

11. A method of marketing, as recited in claim 10, further including a server connected to said wide area network, said server capable of receiving said identity and physical location information to create said user file.

12. A method of advertising, as recited in claim 11, the step (c) of determining the physical location of said electronic device is accomplished using a global positioning satellite system which provides global coordinate information of said electronic device.

13. A method of advertising as recited in claim 12 wherein step (d) is carried out using information transmitted by said electronic device when connected to said network.

14. A method of marketing, as recited in claim 11, wherein said step (c) is carried out by a cellular telephone system capable of determining the physical location of a cellular telephone used to connect to said wide area network.

15. A method of marketing, as recited in claim 11, wherein said server is also the network service provider that provides said electronic device access to said wide area network.

16. A method of marketing, as recited in claim 15, wherein said step (a) of identifying said electronic device is accomplished by determining the numerical address assigned to said electronic device by said server.

17. A method of marketing, as recited in claim 11, wherein said step (a) of identifying said electronic device is accomplished using client software to transmit identification information.

18. A method of marketing, as recited in claim 15, wherein said server collects said network connection activities information and adds it to said user file.

19. A method of marketing, as recited in claim 15, wherein said server collects personal data of said user of said electronic device and adds it to said user file.

20. A method of localized network marketing, comprising the following steps:
a. identifying an electronic device having means to make a wireless connection to a wide area network;
b. identifying the user of said electronic device;
c. determining the physical location of said electronic device when connected to said wide area network;
d. determining the network connection activities of said electronic device;
e. creating a user file containing information of the identity of said electronic device, the identity of said user and the physical location of said electronic device when connected to the network;
f. selecting advertising material to be sent to the user; and
g. transmitting said advertising material to said user over said wide area network using the electronic device identity, user identity and physical location information in said user file.

21. A method of marketing, as recited in claim 20, further including a server connected to said wide area network, said server capable of receiving said identity and physical location information to create said user file.

22. A method of marketing as recited in claim 20 wherein step (c) is carried out using information transmitted by said electronic device when connected to said network.
